(19) United States
(12) Patent Application Publication
(10) Pub. No.: US 2013/0301392 A1
(43) Pub. Date: Nov. 14, 2013

(54) METHODS AND APPARATUSES FOR COMMUNICATION OF AUDIO TOKENS

(71) Applicant: ZULU HOLDINGS, INC., Grand Cayman (KY)

(72) Inventor: Guochun Zhao, Cupertino, CA (US)

(73) Assignee: Zulu Holdings, Inc., Grand Cayman (KY)

(21) Appl. No.: 13/890,101

(22) Filed: May 8, 2013

Related U.S. Application Data
(60) Provisional application No. 61/644,058, filed on May 8, 2012.

(51) Int. Cl. H04B 11/00

(52) U.S. Cl. CPC H04B 11/00
USPC 367/135; 367/137

(57) ABSTRACT

An apparatus for transmitting audio tokens includes an acoustic transmitter to generate a range of audio frequencies including an infrasonic range, a sonic range, and an ultrasonic range. An audio token generator assembles the audio tokens, which include a timestamp and an identifier, and modulates the audio token in to the range of audio frequencies. A synchronizer determines the timestamp relative to an input audio stream and a mixer mixes the audio stream and the audio token for presentation by the acoustic transmitter. An apparatus for receiving the audio tokens includes an acoustic receiver to receive the range of audio frequencies. An audio token extractor extracts the audio token including the timestamp and the identifier from the range of audio frequencies. An interpreter determines user information responsive to at least one of the timestamp and the identifier and a user interface element present the user information to a user.

### CROSS-REFERENCE TO RELATED APPLICATIONS

This application claims priority to U.S. Patent Provisional Application Ser. No. 61/644,058, filed May 8, 2012, pending, the disclosure of which is incorporated herein by reference in its entirety.

### TECHNICAL FIELD

Embodiments of the present disclosure relate generally to communicating tokens and, more particularly, to methods and apparatuses for communicating audio tokens.

### BACKGROUND

Mobile devices and other computing and communication devices are becoming virtually ubiquitous in today's society. These devices, with their wireless communication capabilities, allow a user to keep connected with the world in new ways. However, there are still untapped ways to use these devices and communicate with them. Some new communication means may be less intrusive and add value to the devices as well as systems communicating with the devices.

There is a need for methods and apparatuses that include new ways to pass information to computing devices and communication devices that do not use traditional wireless frequency spectra.

### BRIEF DESCRIPTION OF THE SEVERAL VIEWS OF THE DRAWINGS

FIG. 1 illustrates a computing system for practicing some embodiments of the present disclosure;

FIG. 2 illustrates an example format for an audio token;

FIG. 3 illustrates a system for embedding audio tokens into media files, transmitting media information with the embedded audio tokens, and receiving the media information with the embedded audio tokens on mobile devices;

FIG. 4 illustrates a process for embedding audio tokens into media files;

FIG. 5 illustrates a process for combining audio tokens and media information, then transmitting the combination;

FIG. 6 illustrates a process for combining audio tokens and media information, then transmitting the combination from multiple media players;

FIG. 7 illustrates a system for presenting information on mobile devices that is substantially synchronized with media information and audio tokens embedded in the media information;

FIG. 8 illustrates a system for embedding audio tokens into media files with various different usage models for the audio tokens; and

FIG. 9 illustrates a system for embedding audio tokens into media files with additional usage models for the audio tokens.

### DETAILED DESCRIPTION

In the following description, reference is made to the accompanying drawings in which is shown, by way of illustration, specific embodiments of the present disclosure. The embodiments are intended to describe aspects of the disclosure in sufficient detail to enable those skilled in the art to practice the invention. Other embodiments may be utilized and changes may be made without departing from the scope of the disclosure. The following detailed description is not to be taken in a limiting sense, and the scope of the present invention is defined only by the appended claims.

Furthermore, specific implementations shown and described are only examples and should not be construed as the only way to implement or partition the present disclosure into functional elements unless specified otherwise herein. It will be readily apparent to one of ordinary skill in the art that the various embodiments of the present disclosure may be practiced by numerous other partitioning solutions.

In the following description, elements, circuits, and functions may be shown in block diagram form in order not to obscure the present disclosure in unnecessary detail. Additionally, block definitions and partitioning of functions between various blocks is exemplary of a specific implementation. It will be readily apparent to one of ordinary skill in the art that the present disclosure may be practiced by numerous other partitioning solutions. Those of ordinary skill in the art would understand that information and signals may be represented using any of a variety of different technologies and techniques. For example, information, and signals that may be referenced throughout the description may be represented by voltages, currents, electromagnetic waves, magnetic fields, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

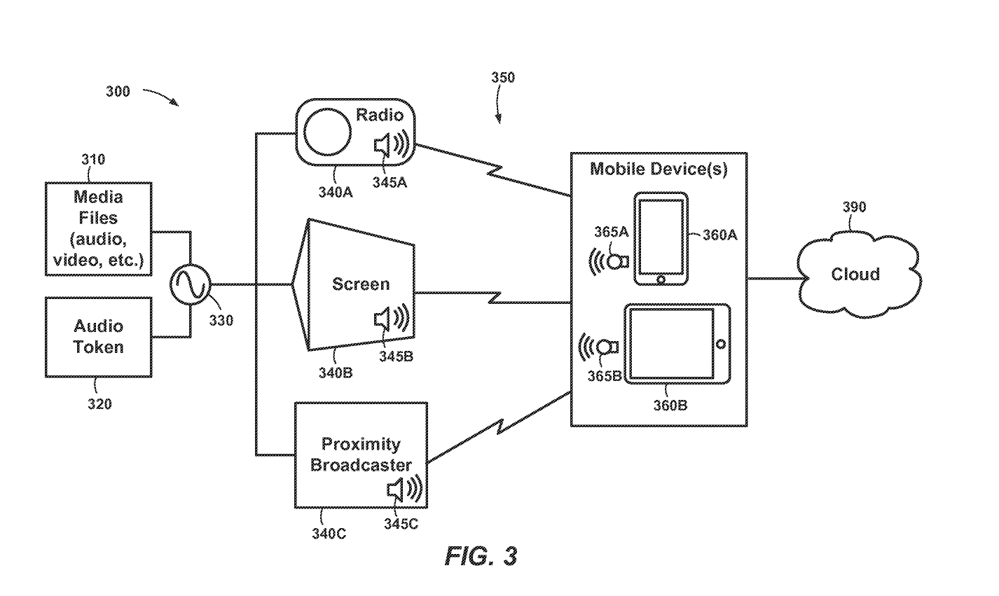

Elements described herein may include multiple instances of the same element. These elements may be generically indicated by a numerical designator (e.g. 110) and specifically indicated by the numerical indicator followed by an alphabetic designator (e.g., 110A) or a numeric indicator preceded by a “dash” (e.g., 110-1). For ease of following the description, for the most part element number indicators begin with the number of the drawing on which the elements are introduced or most fully discussed. For example, where feasible elements in FIG. 3 are designated with a 3 format of 3xx, where indicates FIG. 3 and xx designates the unique element.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner. In addition, unless stated otherwise, a set of elements may comprise one or more elements.

As used herein the term “sonic range” refers to a range of acoustic frequencies that may be audible to humans and are generally considered to be in the range of about 20 Hz to about 20 kHz.

As used herein, the term “infrasonic range” refers to a range of acoustic frequencies that may be inaudible to humans, but generally can be generated by acoustic transmitters (e.g., speakers) and detected by acoustic receivers (e.g., microphones) present in electronic devices. As a non-limiting example, the infrasonic range may refer to a range of about 1 Hz to about 20 Hz. However, the lower end of the range may vary depending on capabilities of the acoustic transmitters and acoustic receivers used in systems discussed herein.

As used herein, the term “ultrasonic range” refers to a range of acoustic frequencies that may be inaudible to humans, but generally can be generated by acoustic transmitters and detected by acoustic receivers present in electronic devices. As a non-limiting example, the ultrasonic range may refer to a range of about 20 kHz to about 22 khz. However, the upper end of the range may vary depending on capabilities of the acoustic transmitters and acoustic receivers used in systems discussed herein.

Unless specifically stated otherwise, the term “audio,” as used herein, refers to a range of acoustic frequencies in a combination of the infrasonic range, sonic range, and ultrasonic range.

Embodiments of the present disclosure include various combinations of transmitters, receivers, and servers to create, communicate, and use audio tokens embedded into audio information. The audio tokens can be used in a variety of different usage models, some examples of which are discussed below.

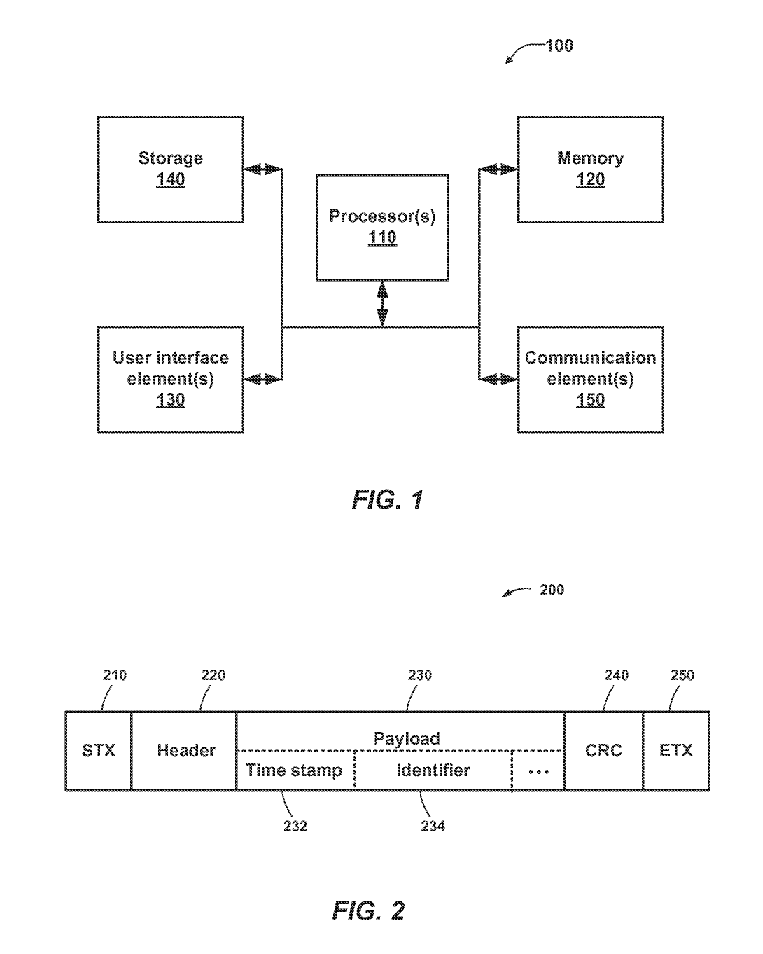

FIG. 1 illustrates a computing system 100 for practicing embodiments of the present disclosure. The computing system 100 may be a user-type computer, a file server, a compute server, a notebook computer, a tablet, a handheld device, a mobile device, or other similar computer system for executing software. Computer, computing system, mobile device, and server may be used interchangeably herein to indicate a system for practicing embodiments of the present disclosure. The computing system 100 is configured for executing software programs containing computing instructions and may include one or more processors 110, memory 120, one or more user interface elements 130, one or more communication elements 150, and storage 140.

The one or more processors 110 may be configured for executing a wide variety of operating systems and applications including computing instructions for carrying out embodiments of the present disclosure.

The memory 120 may be used to hold computing instructions, data, and other information for performing a wide variety of tasks including performing embodiments of the present disclosure. By way of example, and not limitation, the memory 120 may include Synchronous Random Access Memory (SRAM), Dynamic RAM (DRAM), Read-Only Memory (ROM), Flash memory, and the like.

As non-limiting examples, the user interface elements 130 may include elements such as displays, keyboards, mice, joysticks, haptic devices, microphones, speakers, cameras, and touchscreens.

As non-limiting examples, the communication elements 150 may be configured for communicating with other devices or communication networks. As non-limiting examples, the communication elements 150 may include elements for communicating on wired and wireless communication media, such as for example, serial ports, parallel ports, Ethernet connections, universal serial bus (USB) connections IEEE 1394 (“firewire”) connections, Bluetooth wireless connections, 802.1 a/b/g/n type wireless connections, cellular telephone networks, and other suitable communication interfaces and protocols.

The storage 140 may be used for storing relatively large amounts of non-volatile information for use in the computing system 100 and may be configured as one or more storage devices. By way of example, and not limitation, these storage devices may include computer-readable media (CRM). This CRM may include, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory, and other equivalent storage devices.

Software processes illustrated herein are intended to illustrate representative processes that may be performed by the systems illustrated herein. Unless specified otherwise, the order in which the process acts are described is not intended to be construed as a limitation, and acts described as occurring sequentially may occur in a different sequence, or in one or more parallel process streams. It will be appreciated by those of ordinary skill in the art that many acts and processes may occur in addition to those outlined in flow charts. Furthermore, the processes may be implemented in any suitable hardware, software, firmware, or combinations thereof. When executed as firmware or software, the instructions for performing the processes may be stored on a computer-readable medium.

By way of non-limiting example, computing instructions for performing the processes may be stored on the storage 140, transferred to the memory 120 for execution, and executed by the processors 110. The processor 110, when executing computing instructions configured for performing the processes, constitutes structure for performing the processes and can be considered a special-purpose computer when so configured. In addition, some or all portions of the processes may be performed by hardware specifically configured for carrying out the processes.

The computing system 100 may be configured as a server to provide information and databases for embodiments of the present disclosure. The computing system 100 also may be used for generating audio tokens, embedding audio tokens into media files or audio information being transmitted, and receiving and decoding audio tokens. The computing systems may also be used for communicating with local databases, remote databases, or combinations thereof. An audio token is a piece of information that may be inserted into media information that includes audio information. The audio tokens may include a variety of information.

FIG. 2 illustrates an example format for an audio token. The audio token may include a start indicator 210 to indicate a start of transmission of the audio token and an end indicator 250 to indicate an end of transmission of the audio token. A header 220 may be used and may include information such as, for example, version information and information about the type of payload 230.

The payload 230 includes a timestamp 232 and an identifier 234. Other information may also be included within the payload as indicated by the ellipses after the identifier 234. The identifier 234 may include different information for different usage models. As non-limiting examples, the identifier 234 may include information about the media that the audio token 200 is embedded in, information about a specific location where the audio token 200 is being transmitted, information about the sender that is transmitting the audio token 200, and information about transactions that may be performed relative to the sender and/or location from which the audio token 200 is being transmitted.

Cyclic Redundancy Check (CRC) information 240, other error checking information, or other error correction information may also be included to determine or improve the integrity of any received audio tokens.

FIG. 3 illustrates a system 300 for embedding audio tokens 200 into media files 310, transmitting media information with the embedded audio tokens 200, and receiving the media information with the embedded audio tokens 200 on mobile devices 360A and 360B. Referring to FIGS. 2 and 3, a synchronizer 330 is used to examine media information in the form of, for example, one or more media files 310 or streaming media information 310.

Media information 310 may include audio information, video information, combinations, thereof, as well as other information. The audio token 200 is embedded into the audio portion of the media information 310. Media information 310, may be generally referred to herein as a media stream 310 and the context of whether it is streaming media, a media file, or a combination thereof will be apparent from the description.

This examination of the media stream 310 may be performed as preprocessing, or may be performed substantially real-time as the media stream 310 is to be transmitted. The synchronizer 330 determines a timestamp 232 defining a temporal position within the media stream 310, a clock time, or a combination thereof. The timestamp 232 may then be assembled with other information to create the audio token 200. The audio token 200 may then be embedded into the audio stream portion of the media stream 310 at the appropriate time and matching the timestamp 232 if needed. The devices where the timestamp 232 is determined and where the audio token 200 is assembled and embedded, may vary depending on usage models.

As non-limiting examples, the audio token 200 and media stream 310 in FIG. 3 may be synchronized and combined in one or more broadcasters 340, such as, for example, a radio 340A, a screen 340B, and a proximity broadcaster 340C.

The audio portion of the media stream 310 along with the embedded audio token 200 is converted to sound waves and transmitted 350 by an acoustic transmitter 345 (e.g., a speaker) in the broadcaster 340. Thus, in the example of FIG. 3, each of the radio 340A, the screen 340B, and the proximity broadcaster 340C include an acoustic transmitter (345A, 345B, and 345C, respectively). As a non-limiting example, the screen 340B may be a screen in a movie theater, a screen in a home such as a television screen, or an electronic display such as a billboard, an outdoor display, an advertising display, a kiosk, or an entertainment venue display. Non-limiting examples of proximity broadcasters 340C include audio presentation and/or other media presentation including audio at specific locations such as retail outlets, restaurants, coffee shops, and entertainment venues.

One or more mobile devices (360A and 360B) may be configured to receive the sound waves including the audio stream and the embedded audio token 200 using an acoustic receiver 365 (e.g., a microphone). Thus, in the example of FIG. 3, each of the mobile device 360A and the mobile device 360B include an acoustic receiver (365A and 365B, respectively) that converts the incoming sound waves to an audio stream in the form of an analog signal, a digital signal, or a combination thereof.

The mobile devices 360 include an audio token extractor in the form of software, hardware, or a combination thereof, that receives the incoming audio stream, recognizes the embedded audio tokens 200, and extracts the embedded audio tokens 200 from the audio stream. The mobile devices 360 also include an interpreter that uses information in the audio token 200 to access a database, which may be local on the device, or accessed through a communication element 150 (FIG. 1) from an off-device source, such as, for example, a cloud 390, the Internet, or other accessible source. The user information that is extracted from the database in response to information in the audio token 200 such as the timestamp 232 and the identifier 234 may be presented to the user on one or more user interface elements 130 (FIG. 1).

The audio token may be encoded into an audio stream in a number of ways. As non-limiting examples, the audio token may be modulated onto a baseband signal in the infrasonic, sonic, or ultrasonic ranges using amplitude modulation, frequency modulation, phase shifting and other similar encoding and modulation methods. The audio token may be generated as a serial ASCII stream, or any other digital encoding suitable for representing the audio token in a format such as the example format outlined in the discussion of FIG. 2 above.

The audio token 200 is generally configured to be inaudible to humans, while still being able to be transmitted by an acoustic transmitter 345 and received by an acoustic receiver 365. As non-limiting examples, the audio token may be placed in the infrasonic range or the ultrasonic range. In addition, while the upper end of the sonic range is generally considered to extend to 20 kHz, most people cannot hear frequencies above 18 kHz. Thus, in some embodiments, the audio token may be placed between about 18 kHz and 20 kHz.

In addition, audio tokens may be placed in frequency ranges of the sonic range that are normally audible to humans. In such cases, the audio token may be substantially masked from recognition by humans using a number of techniques. One such technique is to use amplitude adaptation. Audio token insertion runs in parallel with the master media source when it plays. Thus, the amplitude of the audio token signal may “adapt” to the amplitude of the master media source. In other words, when the media source is loud, the audio token signal will be louder, but still substantially imperceptible. If the media source weakens out, the audio token signal will be quieter. By being adaptive, audio token signals stay at a level that is proportionate to the source, avoiding any pitch that may stand out as not belonging to the original media stream.

Another such technique may be to temporally spread the audio token signal over a longer time period such that any change in the combination of the audio token signal and the master media source is substantially imperceptible to a human.

Some non-limiting examples of uses for the audio tokens include subtitle text displaying for the deaf or for audiences who need real-time translations during movies, shows, or conferences. Another non-limiting example is for real-time mobile advertising, product/service promotions, and shopping applications targeted to users who are watching TV, listening to the radio, or walking into a store where there is an audio program playing. Another non-limiting example is for enabling users to be interactive with outdoor screens or displays that have speakers to get instant coupons, or to buy tickets for an event or for transportation.

In some master media streams such as movies or TV, the audio tokens may be synchronized with the timestamp to specific temporal positions in the master media stream enabling user information to be presented on the mobile device 360 such as captioning or enhanced information not available in the mater media stream.

Audio token receivers are generally described herein as mobile devices 360, however any electronic device that includes the audio token extractor and interpreter capabilities in software, hardware, or a combination thereof may be used.

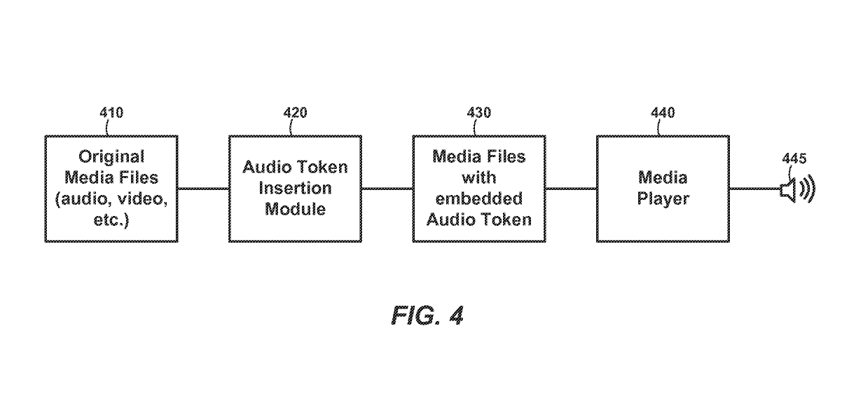

FIG. 4 illustrates a process for embedding audio tokens into media files. The process may be performed on any suitable computing system and may be included as a software module in a server, a computer, a mobile device, a media processor, or part of a broadcaster 340. Operation block 410 indicates that a computing system may be used to read in, decompress if necessary, and interpret an original media file. The original media file may be in any suitable format including audio information such as, for example, an MP3 audio file or an MP4 audio/video file.

The synchronizer 330 (FIG. 3) determines appropriate time stamps for any audio tokens to be inserted relative to the original media file. Operation block 420 indicates that the audio tokens are created with appropriate timestamps and inserted into the original media stream.

Operation block 430 indicates that the new media stream including the embedded audio tokens is encoded and compressed if desired in any appropriate format and stored in a new media file. The new media file includes the original media stream from the original media file and the embedded audio tokens in a single media stream. Operation block 440 indicates that the new media file may be interpreted and played by any suitable media player and the audio portion may be broadcast on an acoustic transmitter 445.

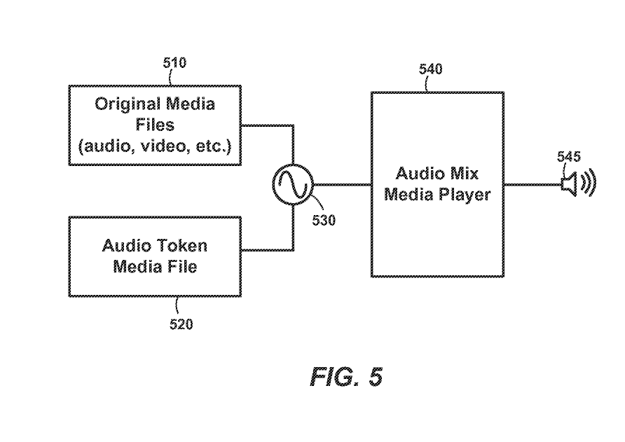

FIG. 5 illustrates a process for combining audio tokens and media information, then transmitting the combination. The process may be performed on any suitable computing system and maybe included as a software module in a server, a computer, a mobile device, a media processor, or part of a broadcaster 340. Operation block 510 indicates that a computing system may be used to read in, decompress if necessary, and interpret an original media file. The original media file may be in any suitable format including audio information such as, for example, an MP3 audio file or an MP4 audio/video file.

The synchronizer 330 (FIG. 3) determines appropriate time stamps for any audio tokens to be embedded relative to the original media stream. Operation block 520 indicates that the audio tokens are created as a separate audio token stream, which may be encoded and compressed if desired in any appropriate format and stored in an audio token media file.

Many media players are capable of mixing different media streams as they are played. In the process of FIG. 5, the original audio stream in the media file and the token audio stream in the token media file are both sent to the mixing media player. Operation block 540 indicates that the two media streams may be interpreted, combined, and played by any suitable mixing media player and the audio portion may be broadcast on an acoustic transmitter 545.

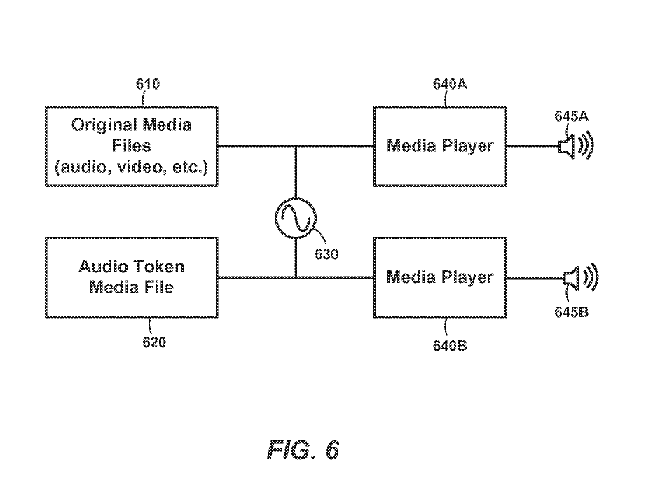

FIG. 6 illustrates a process for combining audio tokens and media information, then transmitting the combination from multiple media players. The process of FIG. 6 is similar to that of FIG. 5 in that an audio token stream is created and stored in a separate audio token media file with time stamps synchronized to the original media stream. In some venues (e.g., a movie theater), one or more separate speakers may be available for playing a different audio stream from the original audio stream. In such systems, the original audio stream may be directed to one media player 640A and a set of speakers 645A. In synchronization, the audio token media file may be directed to another media player 640B and another set of one or more speakers 645B. In this way, the original audio stream and the audio token stream are combined in the medium carrying the sonic waves as they are played.

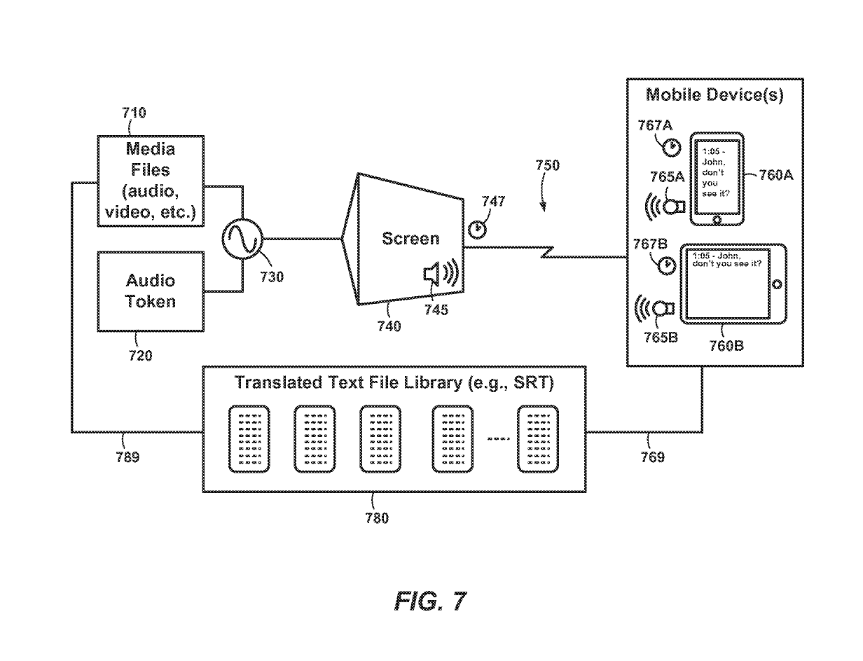

FIG. 7 illustrates a system for presenting information on mobile devices that is substantially synchronized with media information and audio tokens embedded in the media information. The media files, 710, audio tokens 720, synchronizer 730, screen 740, acoustic transmitter 745, transmission 750, mobile devices (760A and 760B) and acoustic receivers (765A and 765B) are similar to those of FIG. 3 and need not be explained again.

The usage model of FIG. 7 may be useful in scenarios such as playing a movie. Clocks (747, 767A and 767B) indicate that periodic audio tokens transmitted from the screen 740 keep the mobile devices (760A and 760B) in substantial synchronization throughout the playing of the movie or other media presentation. The mobile devices (760A and 760B) include the audio token extractor and interpreter to access one or more databases in response to information such as timestamps and identifiers in the audio tokens. As a non-limiting example, the identifier may indicate a specific movie or media presentation with supplemental information that may be presented to the user on the mobile devices (760A and 760B) along with the information presented on the screen 740.

For example, a foreign film may be in another language from what the user understands, or a hearing-impaired user may be viewing a movie. The audio tokens may be synchronized to the foreign film or movie and transmitted with the audio of the foreign film or movie. The mobile devices (760A and 760B) use the audio tokens to access a database of text 780 (e.g., SubRip Text (SRT) file or other suitable text including the dialogue), the text may be presented on a screen of the mobile devices (760A and 760B) at the appropriate and substantially synchronized time. Moreover, a speech synthesis tool on the mobile devices (760A and 760B) may be included to convert the text to speech, which may be presented to the user on the mobile devices (760A and 760B) as audio through a speaker or headphones at the appropriate and substantially synchronized time.

This usage model may also be used in a setting such as a conference including presentations. The audio tokens may be synchronized to slides or other media of a presentation and the supplemental information may be accessed from the database and presented to the user at the appropriate times. Each user of a mobile device (760A or 760B) may select a different language and software on the mobile devices (760A and 760B) would use this information, along with the identifier and timestamp to access a different database or access different data within a combined data base to obtain the supplemental information in an appropriate language.

Those of ordinary skill in the art will recognize that the supplemental information may include many other types of media and information other than text. As non-limiting examples, the supplemental information may include augmenting audio, video, or images. As other non-limiting examples, the supplemental information may include background information about the presenter, actors, locations, or other details about the media presentation.

As stated earlier, the database including the supplemental information may be local on the mobile devices (760A and 760B), accessed through the Internet or other remote source, or a combination thereof.

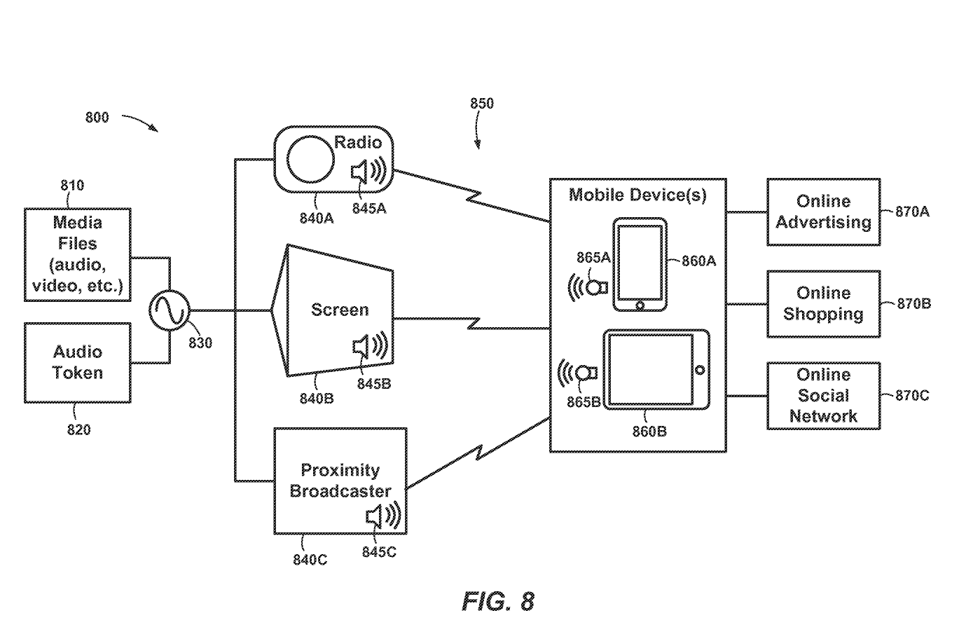

FIG. 8 illustrates a system for embedding audio tokens into media files with various different usage models for the audio tokens. The media files, 810, audio tokens 820, synchronizer 830, broadcasters (840A, 840B, and 840C), acoustic transmitters (845A, 845B, and 845C), transmission 850, mobile devices (860A and 860B) and acoustic receivers (865A and 865B) are similar to those of FIG. 3 and need not be explained again. The FIG. 8 usage model may be targeted to location based customizations as well as time-based customizations. The audio tokens may be used to connect to various online functions or online information, such as, for example, online advertising 870A, online shopping 870B, and online social networking 870C. In such a usage model, the identifiers in the audio tokens may indicate a specific location, such as, for example, a coffee shop, a restaurant, or an entertainment venue.

With such location, and possibly time information, online advertising 870A may be accessed and presented to users on the mobile devices (860A and 860B) that is targeted to a specific location, time, or combination thereof. Moreover, applications on the mobile devices (860A and 860B), or remotely accessed, may include information about the user such that the advertising can be even more specific to the user's background, or other personal indicators.

Online shopping 870B may be included and present information to the user, such as, for example, a menu for the restaurant broadcasting the audio tokens, or a list of styles and prices for clothing in a clothing store. Other possible models may include advertising during certain time periods. As a non-limiting example, an entertainment venue may advertise certain types of refreshments during certain times, such as during an intermission or prior to the start of the entertainment.

Online social networking 870C may be accessed to connect multiple users with mobile devices (860A and 860B) at a certain location, such as, for example, an entertainment venue. As a non-limiting example, connected users may exchange comments or other information about a sporting event at a venue that they are attending based on what is occurring as indicated by timestamps and identifiers in the audio tokens.

Other online information may also be accessed. As a non-limiting example, audio tokens at an entertainment venue presented at the end of the entertainment or as patrons are leaving may direct the mobile devices ((860A and 860B) to real-time information regarding traffic patterns near the venue so a user can plan a route away from the venue.

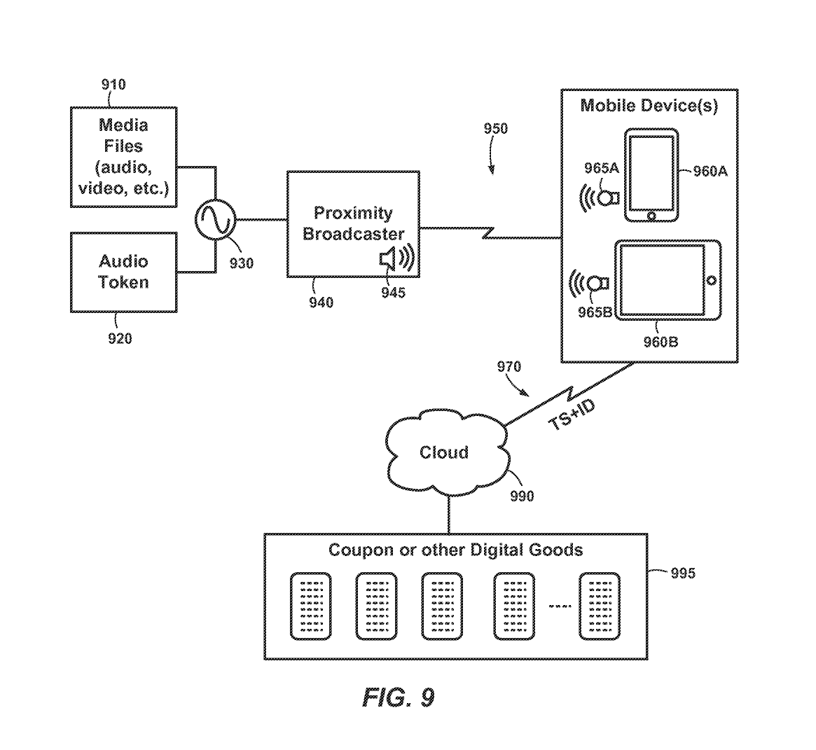

FIG. 9 illustrates a system for embedding audio tokens into media files with additional usage models for the audio tokens. The media files, 910, audio tokens 920, synchronizer 930, proximity broadcaster 940, acoustic transmitter 945, transmission 950, mobile devices (860A and 860B) and acoustic receivers (865A and 865B) are similar to those of FIG. 3 and need not be explained again.

The FIG. 9 usage model may be targeted to location based customizations as well as time-based customizations. The audio tokens may be used to connect to various online functions or online information, such as, for example, coupons, menus, or other information tailored to a specific location or a specific type of store or restaurant.

As a non-limiting example, a coffee shop may be supplied with a system that may insert customizable audio tokens into background music presented at the coffee shop. Alternatively, any conventional computer, communication device, or mobile device may include appropriate software to create the audio tokens and mix them with background music or other audio streams in either a pre-processing process or a real-time process.

The audio tokens may direct the user to specific websites or present the users with information on the mobile devices (860A and 860B) such as coupons, specials, or menus. The audio tokens may also connect the user with specific data for the coffee shop to automatically update information for the user related to purchases such as awarding loyalty points and tracking purchasing history.

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. An apparatus for transmitting one or more audio tokens, comprising:
an acoustic transmitter configured to generate transmitted audio over a range of audio frequencies within one or more of an infrasonic range, a sonic range, and an ultrasonic range;
an audio token generator configured to:
assemble an audio token including a timestamp and an identifier;
modulate the audio token onto one or more frequencies in the range of audio frequencies;
a synchronizer for determining the timestamp relative to an input audio stream; and
a mixer for mixing the input audio stream and the audio token for presentation by the acoustic transmitter as the transmitted audio.

2. The apparatus of claim 1, wherein the one or more frequencies are in the infrasonic range.

3. The apparatus of claim 1, wherein the one or more frequencies are in the infrasonic range.

4. The apparatus of claim 1, wherein the one or more frequencies are in a range of about 18 kHz to about 20 kHz.

5. The apparatus of claim 1, wherein the one or more frequencies are in the sonic range and the mixer is further configured to mix the audio token with the input audio stream with amplitude adaptation such that an amplitude of the audio token is sufficiently higher that the input audio stream to be detected by an apparatus for receiving the audio tokens but not so much higher that the audio token is substantially perceivable by a human.

6. The apparatus of claim 1, wherein the one or more frequencies are in the sonic range and the mixer is further configured to mix the audio token with the input audio stream with a temporal spread such that the audio token is sufficiently spread in time so as to be substantially unperceivable by a human but detectable by an apparatus for receiving the audio tokens.

7. The apparatus of claim 1, wherein the mixer is further configured to mix the input audio stream and the audio token in substantially real-time for presentation by the acoustic transmitter as the transmitted audio.

8. The apparatus of claim 1, wherein the mixer is further configured to mix the audio token with the input audio stream from a file including the input audio stream.

9. A apparatus for receiving one or more audio tokens, comprising:
an acoustic receiver configured to receive a received audio in a range of audio frequencies including one or more of an infrasonic range, a sonic range, and an ultrasonic range;
an audio token extractor configured to extract an audio token including a timestamp and an identifier from one or more frequencies in the range of audio frequencies;
an interpreter configured to determine user information responsive to at least one of the timestamp and the identifier; and
one or more user interface elements for presenting the user information to a user.

10. The apparatus of claim 9, wherein one or more of the audio token extractor and the interpreter are further configured to cooperatively retrieve from a database, information related to the received audio responsive to at least one of the timestamp and the identifier.

11. The apparatus of claim 10, wherein one or more of the audio token extractor, the interpreter and the one or more user interface elements are configured to cooperatively present the related information in substantial synchronization with the received audio responsive to the timestamp.

12. The apparatus of claim 10, further comprising a communication element and wherein at least some of the related information is retrieved from a source outside the apparatus through the communication element.

13. A method for communicating audio tokens, comprising:
assembling an audio token to include a timestamp and an identifier, wherein the timestamp is correlated to a temporal position within an input audio stream;
modulating the audio token onto one or more frequencies in a range of audio frequencies;
mixing the audio stream and the audio token;
transmitting the mixed audio stream as transmitted audio;
receiving the transmitted audio as received audio;
extracting the audio token including the timestamp and the identifier from the received audio;
determining user information responsive to at least one of the timestamp and the identifier; and
presenting the user information to a user on one or more user interface elements.

14. The method of claim 13, wherein determining the user information further comprises retrieving from a database, information related to the received audio responsive to at least one of the timestamp and the identifier.

15. The method of claim 14, wherein presenting the user information comprises presenting the related information in substantial synchronization with the received audio responsive to the timestamp.

16. The method of claim 14, wherein at least some of the related information is retrieved from a network.17. The method of claim 13, wherein the one or more frequencies are in a sonic range and mixing the audio stream and the audio token is performed with amplitude adaptation such that an amplitude of the audio token is sufficiently higher that the input audio stream to be detected by an apparatus for receiving the audio tokens but not so much higher that the audio token is substantially perceivable by a human.18. The method of claim 13, wherein the one or more frequencies are in a sonic range and mixing the audio stream and the audio token is performed with a temporal spread such that the audio token is sufficiently spread in time so as to be substantially unperceivable by a human but detectable by an apparatus for receiving the audio tokens.19. The method of claim 13, wherein the one or more frequencies are in an infrasonic range.20. The method of claim 13, wherein the one or more frequencies are in an infrasonic range.
